(19) United States
(12) Patent Application Publication
(10) Pub. No.: US 2009/0179123 A1
(43) Pub. Date: Jul. 16, 2009

(54) Single Column Pedestal for a Height-Adjustable Work Station

(75) Inventor: Robert W. Wacker, Plymouth, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Mayline Company, LLC, Sheboygan, WI (US)

(21) Appl. No.: 12/013,779

(22) Filed: Jan. 14, 2008

(51) Int. Cl. F16M 11/00

(52) U.S. Cl. 248/161

(57) ABSTRACT

A pedestal for a height-adjustable work station includes a support base to which a single main support column is attached with a two-part fastening system that places the parts as far apart vertically as is practicable. The vertical spacing of the fastening system strengthens the connection between the base and the support column which supports an actuator and a large work surface. The assembly has adequate stiffness and strength to resist shear and bending moment loads.

### BACKGROUND OF THE INVENTION

The present invention pertains to a work station in the form of desk or table with a work surface that can be adjusted vertically for different users or for the performance of different tasks. In particular, the present invention pertains to a height-adjustable work station that has a single column with a reinforced mounting assembly for attaching the column to the base for enhanced rigidity, particularly to resist horizontal or bending moment loads.

Height-adjustable work stations are well known in the art and are used for a variety of tasks including drafting, computer operations, or as a conventional desk or work table. Many height-adjustable work stations utilize two spaced vertical columns to support and adjust the height of the working surface. Although such two-column work stations provide adequate strength and stability, each requires a separate synchronized drive to effect vertical adjustment. This adds both to the cost and complexity of the apparatus.

Although a single center column support for a height adjustable work surface is more simple and lower in cost, it has been found that prior art single column height-adjustable work stations suffer strength, stability and rigidity problems. These problems may result in alignment, operation and structural failures.

### SUMMARY OF THE INVENTION

In accordance with the present invention, a height-adjustable work station uses a single vertical telescoping support column that is fastened to a supporting base with a two-level fastening system that spaces the fasteners vertically apart at a practical maximum distance to enhance rigidity and stability of the apparatus, and resistance to both shear and bending moment loads.

More particularly, the present invention provides a pedestal for a height-adjustable work station that comprises a supporting base including a pair of elongated feet that are connected by a horizontal base panel. The base panel has upper and lower panel members to which an actuator support column is attached. The actuator support column has a bottom plate secured to the lower end thereof and the bottom plate is attached to the lower panel member. The support column extends vertically upward from the base panel and terminates in a working surface-supporting upper end. The upper panel member of the base has a raised central base plate which surrounds the support column and has an upper surface that is spaced vertically above the upper panel member and defines an opening through which the vertical support column extends. A mounting bracket assembly is secured to the support column and positioned adjacent and attached to the underside of the upper surface of the base plate. The vertical distance between the attachment of the bottom plate to the lower panel member and the attachment of mounting bracket assembly to the upper surface of the base plate maximizes the vertical distance, as discussed above.

Preferably, the vertical support column comprises a rectangular cross section tubular member. The opening in the upper surface of the base plate has a rectangular shape that corresponds to the cross section of the tubular member. The base panel is a box-like structure that includes front and rear webs that interconnect the upper and lower panel members. The apparatus also includes an actuator column that is received in a telescoping manner within the support column. The base plate preferably comprises a deep drawn center portion that is formed integrally in the upper panel member.

The mounting bracket assembly preferably comprises a pair of angle brackets, each of which has a vertical leg attached to a respective opposite side of the support column and a horizontal leg attached to the underside of the upper surface of the base plate. The vertical bracket legs that are attached to the support column are preferably welded thereto, and the horizontal legs are bolted to the base plate. The support column base plate is preferably welded to the lower end of the support column and is bolted to the lower panel member, all in a manner to facilitate assembly.

The actuator column also comprises a rectangular section tubular member, and the apparatus includes an actuator assembly that is mounted within the actuator column and is operatively connected to the support column and the actuator column to effect vertical movement of the actuator column. The lower end of the actuator assembly is attached to the support column bottom plate.

In a modified embodiment of the invention, a pedestal for a height-adjustable work station comprises a horizontal supporting base member that has an upper panel member and a lower panel member; a vertical support column comprising a rectangular cross section tubular member; the upper panel member having a raised central base plate that includes a horizontal upper mounting surface that is spaced vertically above the upper panel member; the lower panel member having a horizontal lower mounting surface; the upper and lower mounting surfaces having respective aligned upper and lower rectangular openings for receipt of the support column; a bottom plate is secured to the lower end of the support column and attached to the underside of the lower panel member; and, a mounting bracket is secured to the support column above the upper panel member and is attached to the underside of the mounting surface.

### BRIEF DESCRIPTION OF THE DRAWINGS

FIG. 1 is a perspective view of the work station pedestal of the present invention.

FIG. 2 is an exploded view of the main components of the pedestal shown in FIG. 1.

FIG. 3 is an exploded perspective view taken from below showing the main support column in relation to the supporting base.

FIG. 4 is a bottom plan view of FIG. 3 after assembly.

### DETAILED DESCRIPTION OF THE PREFERRED EMBODIMENT

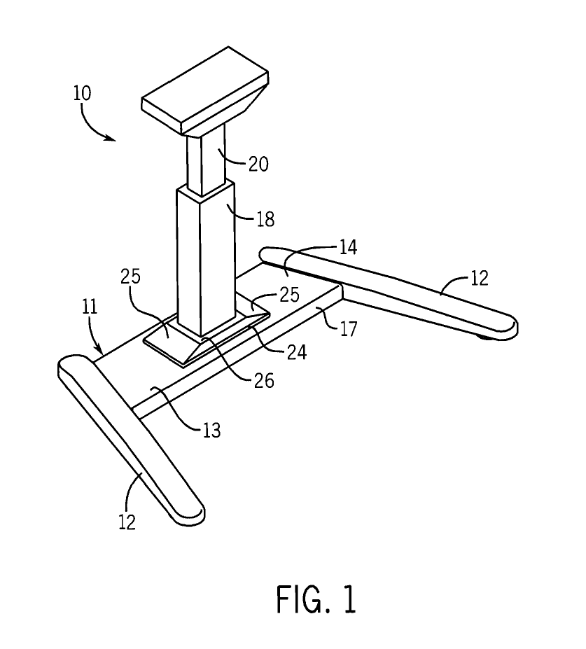

The pedestal 10 for a height-adjustable work station is shown in FIG. 1. The work surface, which may be of varying shapes and sizes, is supported on the top of the pedestal, but has been eliminated for clarity.

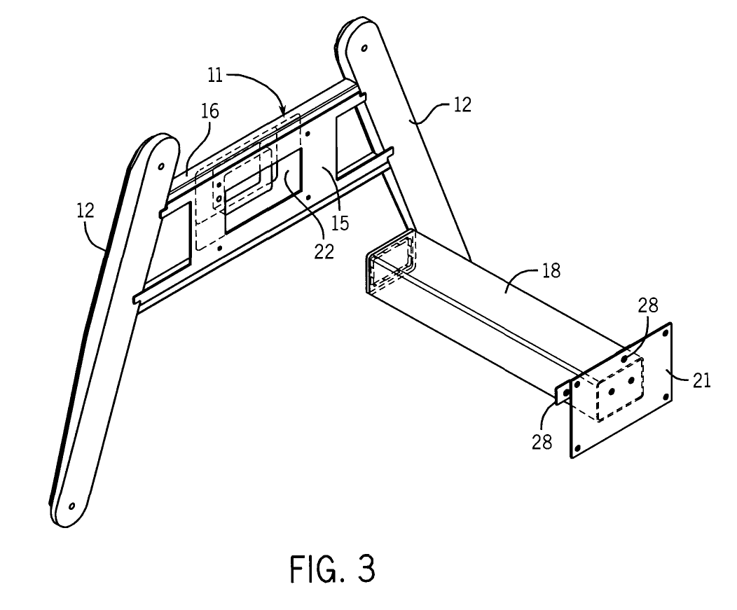

The pedestal 10 includes a supporting base 11 that comprises a pair of elongate feet 12 that are interconnected by a base panel 13. The feet are not parallel and extend from the base panel 13 in a divergent orientation to improve stability of the work station. The base panel 13 is fabricated in a box-like construction that includes generally planar horizontal upper panel member 14 and a parallel lower panel member 15. The upper and lower panel members 14 and 15 are interconnected by front and rear webs 16 and 17, respectively. Front web 16 is shown in FIG. 3. Lower panel member 15 may have access openings 19 to facilitate fabrication and assembly.

A main actuator support column 18 receives an actuator column 20 in a telescoping manner and an internal actuator 35, which is well known in the art, provides vertical movement of the actuator column 20 within the support column 18 to adjust the height of the working surface.

To provide rigid connection of the support column 18 to the base panel 13 in a manner that will provide adequate stiffness and resistance to bending moments and shear loads, a two part fastening system is used in which the parts are vertically separated as far as is practical.

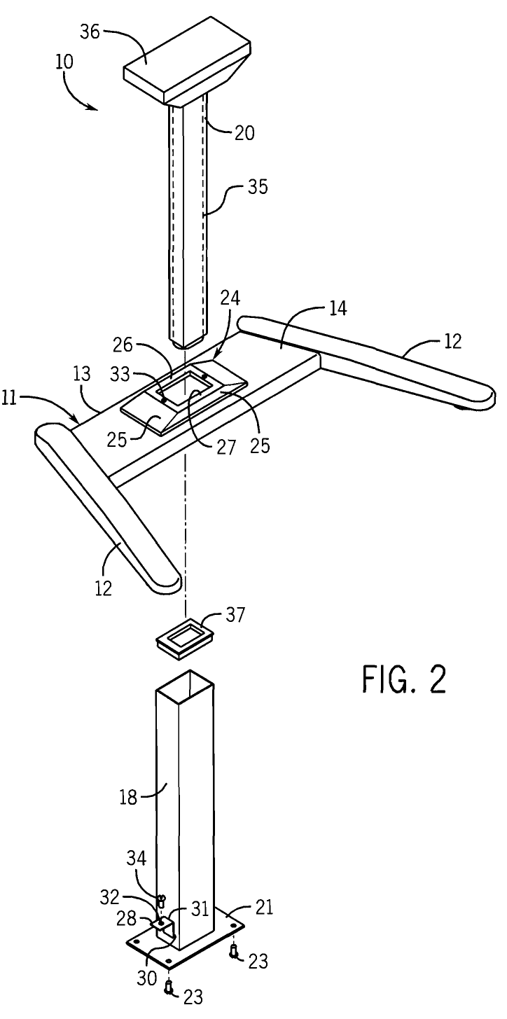

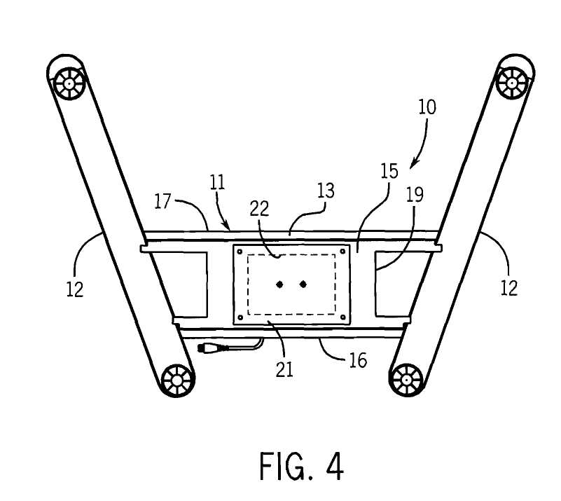

Referring to FIGS. 2, 3 and 4, the support column 18 has a rectangular bottom plate 21 secured to its lower end, preferably by welding. The lower panel member 15 has a rectangular center opening 22 of a size and shape corresponding to the cross section of the support column 18, such that the column can be inserted through the base panel 13 from below. The support column bottom plate 21 contacts the lower surface of the lower panel member 15 and is bolted thereto with four bolts or cap screws 23.

The upper panel member 14 of the base panel 13 includes a raised central base plate 24. Preferably, the raised base plate 24 is formed integrally in the upper panel member 14 by drawing or extrusion. The base plate includes upwardly convergent side faces 25 and a top face 26 parallel to and spaced vertically above the upper panel member 14. The top face 26 of the raised base plate 24 is provided with a rectangular opening 27 of the same size and shape as the center opening 22 in the lower panel member 15 and aligned vertically therewith. The support column 18 thus passes axially through the rectangular opening 27 as the bottom plate 21 is moved into attachment position against the lower panel member 15.

An upper mounting bracket assembly includes a pair of angle brackets 28, each attached by a vertical leg 30 to an opposite face of the support column 18. The vertical legs are preferably attached by welding, but can be connected by other means to the support column. The horizontal legs 31 of the angle brackets 28 are positioned to bear against the underside of the top face 26 of the base plate 24 when the support column bottom plate 21 engages the underside of the lower panel member 15. The horizontal bracket legs 31 are provided with tapped holes that align with holes 33 in the top face 26 adjacent the rectangular opening 27. Appropriate fasteners, such as bolts or cap screws 34 (and lock washers) fasten the angle brackets 28 to the underside of the top face 26 of the base plate 24.

The actuator 35 which is shown only schematically, is attached within the actuator column 20 at its upper end to a housing 36 for the drive motor and controls. The lower end of the actuator is bolted or otherwise connected to the support column bottom plate 21. A glide cap 37, preferably made of a suitable low friction plastic, is mounted on the upper end of the support column 18 and receives the actuator column 20 as it travels vertically within the support column.

I claim:

1. A pedestal for a height-adjustable work station comprising:
a supporting base including a horizontal base panel, the base panel having upper and lower panel members;
an actuator support column having a bottom plate secured to the lower end thereof, the bottom plate attached to the lower panel member;
the support column extending generally vertically upward and terminating in a work surface-supporting upper end;
the upper panel member having a raised central base plate, the base plate surrounding the support column and having an upper surface spaced vertically above the upper panel member and defining an opening through which the support column extends; and,
a mounting bracket assembly secured to the support column and positioned adjacent and attached to the underside of the upper surface of the base plate.

2. The apparatus as set forth in claim 1 wherein the support column comprises a rectangular cross section tubular member, and the opening in the upper surface of the base plate having a rectangular shape corresponding to the cross section of the tubular member.

3. The apparatus as set forth in claim 1 wherein the base panel comprises a box-like structure including front and rear webs interconnecting the upper and lower panel members.

4. The apparatus as set forth in claim 2 including an actuator column received in a telescoping manner in the support column.

5. The apparatus as set forth n claim 2 wherein the base plate comprises a drawn center portion formed integrally with the upper panel member.

6. The apparatus as set forth in claim 2 wherein the mounting bracket assembly comprises a pair of angle brackets each having one leg attached to a respective opposite side of the support column and the other leg attached to the underside of the upper surface of the base plate.

7. The apparatus as set forth in claim 6 wherein said one leg of each angle bracket is welded to the support column and said other leg of each angle bracket is bolted to the base plate.

8. The apparatus as set forth in claim 2 wherein the bottom plate is welded to the lower end of the support column and is bolted to the lower panel member.

9. The apparatus as set forth in claim 8 wherein the support column extends through a rectangular opening in the lower panel member, and the column bottom plate is bolted to the underside of the lower panel member.

10. The apparatus as set forth in claim 4 wherein the actuator column comprises a rectangular section tubular member, the apparatus further including an actuator assembly mounted within the actuator column and operatively connecting the support column and the actuator column to effect vertical movement of the latter.

11. The apparatus as set forth in claim 10 wherein the actuator assembly has a lower end attached to the bottom plate of the support column.

12. A pedestal for a height-adjustable work station comprising:
a horizontal supporting base member having an upper panel member and a lower panel member;
a vertical support column comprising a rectangular cross section tubular member;
the upper panel member having a raised central base plate including a horizontal upper mounting surface spaced vertically above the upper panel member;
the lower panel member having a horizontal lower mounting surface;
the upper and lower mounting surfaces having respective aligned upper and lower rectangular openings for receipt of the support column;
a bottom plate secured to the lower end of the support column and attached to the underside of the lower panel member; and,
a mounting bracket assembly secured to the support column above the upper panel member and attached to the underside of the upper mounting surface.
